(19) United States
(12) Patent Application Publication
(10) Pub. No.: US 2002/0054410 A1
(43) Pub. Date: May 9, 2002

(54) Optically communicable electronic apparatus and optical components applicable thereto

(76) Inventors: Yozo Ishikawa, Tokyo (JP); Masayuki Iwase, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/902,442

(22) Filed: Jul. 9, 2001

(30) Foreign Application Priority Data
Jul. 11, 2000 (JP) 2000-209835

(51) Int. Cl. H04B 10/00

(52) U.S. Cl. 359/159; 359/152; 359/163

(57) ABSTRACT

An electronic apparatus according to the present invention is provided with an optical transmitter, an optical receiver, and a connection part capable of connection to and disconnection from a connection part of another electronic apparatus, and has an internal space in the connection part, which is configured, when the connection part is connected to the connection part of the other electronic apparatus, to communicate with an internal space of the connection part of the other electronic apparatus, constituting a light transmitting space between the two electronic apparatuses, and a shielding mechanism provided at an opening of the connection part, which is configured, when the connection part is connected to the connection part of the other electronic apparatus, to open the opening, allowing an optical signal to be transmitted in the light transmitting space, and when the connection part is not connected to the connection part of the other electronic apparatus, to close the opening, effecting a shielding not to project the optical signal output from the optical transmitter outside the electronic apparatus. An optical component according to the present invention is configured as a module by accommodation into a housing adapted to function as the connection part when devices as well as optical components that constitute the optical transmitter and the optical receiver are assembled in an electronic apparatus.

### FIELD OF THE INVENTION

The present invention relates to an electronic apparatus capable of transmitting and receiving optical signals, and an optical component applicable to the electronic apparatus.

### BACKGROUND OF THE INVENTION

In recent years, most of various electronic apparatuses such as digital cameras, game machines, and audio apparatuses, as well as computers, have communication functions for transmission and reception of data between them.

With miniaturization and mobilization of the electronic apparatuses, there is an increasing demand for cable-less transmission and reception of data. For responding to the demand, there are developed electronic apparatuses capable of transmitting and receiving data by optical communications using infrared rays. This type of electronic apparatus implements so that, when light (an infrared optical signal) modulated in dependence on data to be transmitted from either electronic apparatus is sent out (projected), the infrared optical signal is transmitted through the aerial space as a transmission medium to the other electronic apparatus, where signal reception (light reception) is made.

As the age of multiple media advances, the capacity for data to be transmitted and received between electronic apparatuses is enlarged. As a result, it has become an urgent necessity to establish a technique that enables a large capacity of data to be transmitted and received at a high rate. However, for those electronic apparatuses which perform transmission and reception of optical signals through the aerial space as a transmission medium, it is necessary to keep a human body (in particular the eye) from being badly influenced even if an optical signal projected from electronic apparatus has irradiated the human body by mistake. Therefore, low-output light sources such as light emitting diodes are employed for the optical signal. Data rate is thus limited to an extent of several hundred Mbps. Still less, as the data rate becomes high, the level of optical signal is lowered. It therefore is impossible to answer the demand for transmission and reception of large capacity of data at high rate.

### SUMMARY OF THE INVENTION

According to an aspect of the present invention, an optically communicable electronic apparatus comprises:

an optical transmitter;

an optical receiver;

a connection part capable of connection to and disconnection from a connection part of another electronic apparatus;

an internal space of the connection part; and

a shielding mechanism provided at an opening of the connection part, wherein

the internal space of the connection part is configured, when the connection part is connected to the connection part of the other electronic apparatus, to communicate with an internal space of the connection part of the other electronic apparatus, constituting a light transmitting space between the two electronic apparatuses, and

the shielding mechanism is configured, when the connection part is not connected to the connection part of the other electronic apparatus, to close the opening, effecting a shielding not to project an optical signal output from the optical transmitter outside the electronic apparatus, and when the connection part is connected to the connection part of the other electronic apparatus, to open the opening, allowing the optical signal to be transmitted in the light transmitting space.

According to another aspect of the present invention, an optical component comprises:

a light emitting element;

a light receiving element;

a lens for converging, to output, light projected from the light emitting element;

a lens for converging light incident from outside, to focus on the light receiving element; and

a housing capable of accommodating the light emitting element, the light receiving element, and the lenses, wherein

the housing has a mounting part to be mounted to an electronic apparatus, a connection part capable of connection to and disconnection from another electronic apparatus, and an internal space configured, when the connection part is connected to an optical component mounted to the other electronic apparatus, to communicate with an internal space of the optical component mounted to the other electronic apparatus, constituting a light transmitting space between the two electronic apparatuses, and

an opening of the connection part the housing has is provided with a shielding mechanism, and the shielding mechanism is configured, when the connection part is not connected to the optical component mounted to the other electronic apparatus, to close the opening, effecting a shielding not to project an optical signal output from the light emitting element outside the housing, and when the connection part is connected to the optical component mounted to the other electronic apparatus, to open the opening, allowing the optical signal to be transmitted in the light transmitting space.

### BRIEF DESCRIPTION OF THE DRAWINGS

FIG. 1 is a schematic illustration of an optically communicable electronic apparatus according to a first embodiment of the present invention.

FIG. 2 is an illustration of the optically communicable electronic apparatus shown in FIG. 1, as it is connected to another electronic apparatus.

FIG. 3A is an illustration of a connection part of the optically communicable electronic apparatus shown in FIG. 1, as it is before insertion of an interconnection member, and FIG. 3B is an illustration after insertion of the interconnection member.

FIG. 4A is a fragmentary sectional illustration showing an example of an optical transmitter and an optical receiver, and FIG. 4B is a fragmentary sectional illustration showing an example of a connected condition of connection parts having the optical transmitter and the optical receiver shown in FIG. 4A.

FIG. 5A is an illustration showing a connection process of optically communicable electronic apparatuses according to a second embodiment of the present invention, as it is an example in a condition before connection, and FIG. 5B is an illustration showing an example in a condition after the connection.

FIG. 6 is an illustration showing connection parts of the optically communicable electronic apparatuses according to the second embodiment of the present invention.

FIG. 7A is a partially omitted illustration showing a locking hole provided in the connection part of the optically communicable electronic apparatus according to the second embodiment of the present invention, and FIG. 7B is a fragmentary sectional illustration.

FIG. 8A and FIG. 8B are illustrations showing an example of condition in which shielding lids of the connection parts shown in FIG. 6 are opened.

FIG. 9 is an illustration showing an example of condition in which a locking part of one connection part shown in FIG. 6 is fitted in a locking groove of the other connection part.

FIG. 10A is an illustration showing an example of a connection part of an optically communicable electronic apparatus according to a third embodiment of the present invention, as a partially omitted perspective view, and FIG. 10B is a partially omitted sectional view.

FIG. 11A is an illustration showing an example of a connection process of the electronic apparatuses according to the present invention having the connection part shown in FIG. 10A and FIG. 10B, as it is in a condition before connection, and FIG. 11B is an illustration showing a condition after the connection.

FIG. 12A is a perspective view showing an example of an optical component according to the present invention, and FIG. 12B is a sectional view.

### EMBODIMENTS OF THE INVENTION

(First embodiment of an optically communicable electronic apparatus)

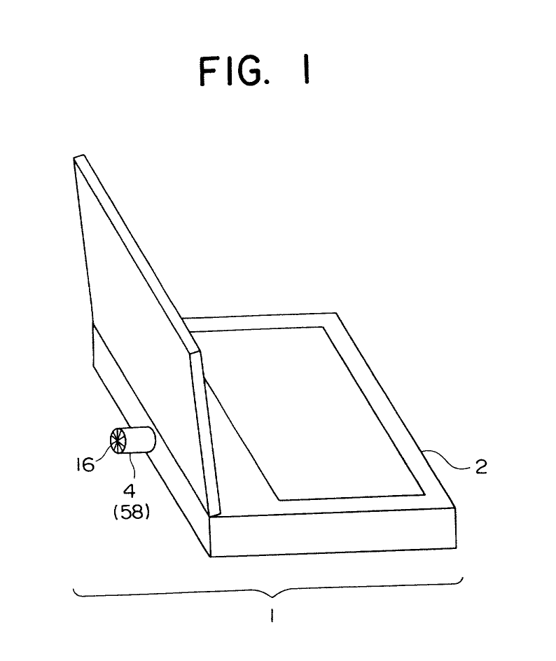

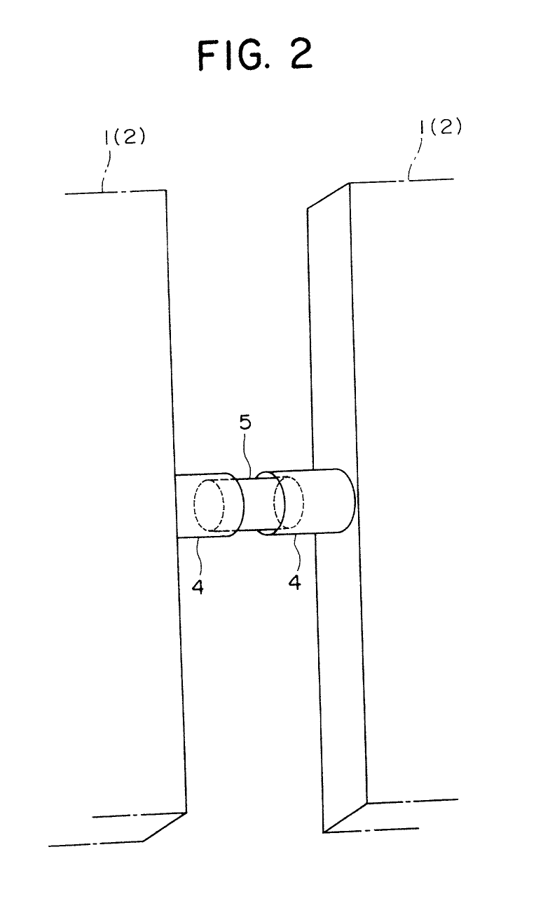

FIG. 1 to FIGS. 4A and 4B show an example of embodiment of an optically communicable electronic apparatus according to the present invention. This electronic apparatus 1 has, as shown in FIG. 1, a connection part 4 provided to an apparatus body 2. As shown in FIG. 2, when the connection part 4 of the electronic apparatus 1 is connected to a connection part 4 of another electronic apparatus via an interconnection member 5, optical communication is enabled between the two electronic apparatuses 1.

The apparatus body 2 is a general notebook type personal computer provided with a keyboard, a liquid crystal display, a CPU, a communication interface circuit, a modem circuit, a picture drawing circuit, a RAM, a ROM, a hard disc, and the like.

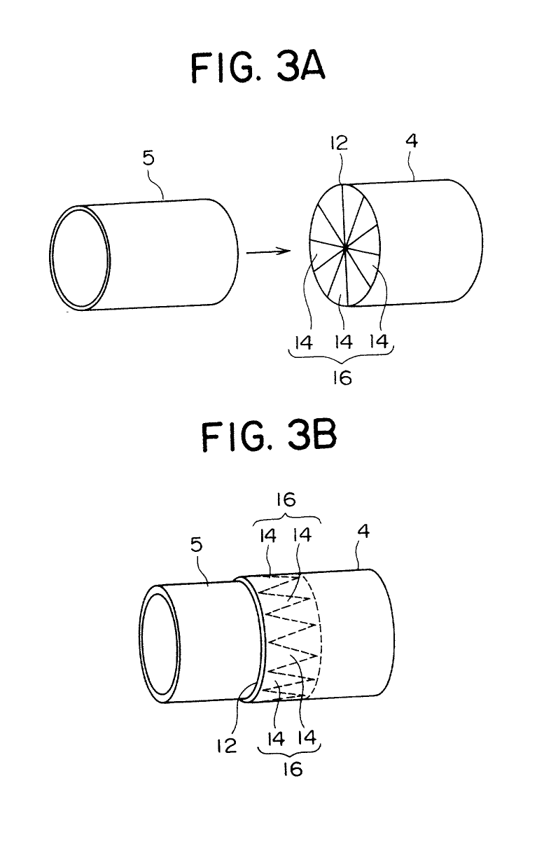

The connection part 4 has an optical transmitter and an optical receiver incorporated in a cylindrical housing. As shown in FIG. 1, the connection part 4 is fixed at one side thereof in the longitudinal direction to the apparatus body 2, and projected at the other side outside of the apparatus body 2. As shown in FIG. 3A, an opening 12 of the connection part 4 is provided with a shielding mechanism (shielding lid 16). The shielding lid 16 is constituted with a multiple number of rubber plates 14 disposed inside the opening 12 along the circumferential direction of the opening 12. A respective rubber plate 14 has a substantially triangular plane form, and as in FIG. 3B, when one end of the interconnection member 5 of an elongate tubular form is inserted inside the connection part 4, the rubber plates 14 are pressed to open inside the connection part 4 so that the opening 12 is opened, and when the interconnection member 5 is pulled out, the rubber plates 14 return by their own resilient restoring forces to original conditions shown in FIG. 3A, so that the opening 12 is automatically closed.

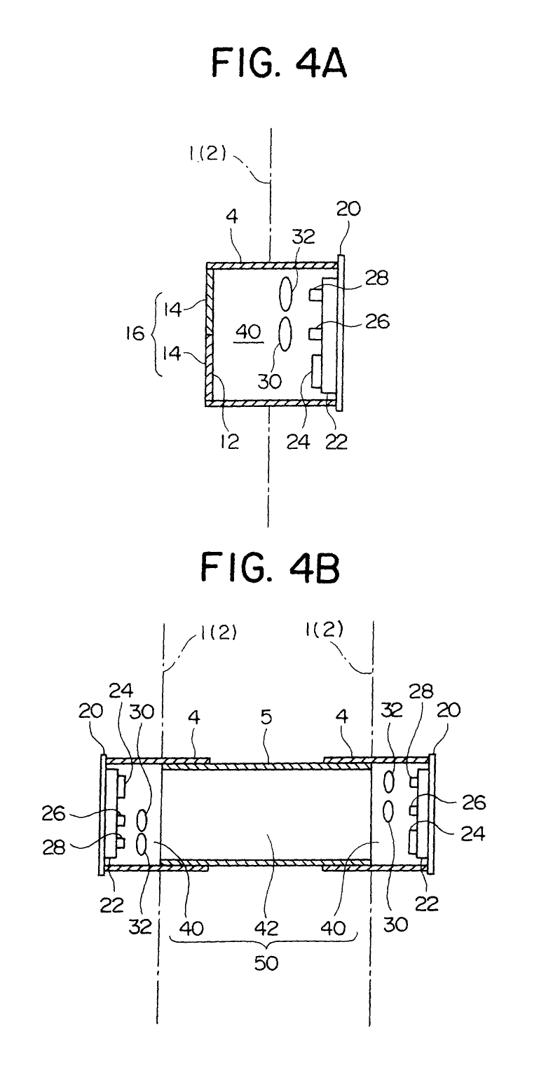

The optical transmitter and the optical receiver incorporated in the connection part 4 are constituted with a lead frame substrate, a relay board, an IC, a light emitting element (LD), a light receiving element (Pin-PD), a lens for converging projected light (an optical signal) from the light emitting element, to output as a converged flux of light, and a lens for converging incident light (an optical signal) from outside, to focus on the light receiving element. More specifically, as shown in FIG. 4A, at one end of the connection part 4 is disposed the lead frame substrate 20 electrically connected to predetermined circuitry of the apparatus body 2, to which the relay board 22 is piled, on which relay board 22 are mounted the IC 24, the light emitting element 26, and the light receiving element 28, and the lenses 30 and 32 are held by plastic or metallic frames (not shown) in respective positions to enable the object to be achieved.

By the above-noted arrangement of the optical transmitter and the optical receiver, when a signal (electric signal) output from the predetermined circuitry of the apparatus body 2 is input to the IC 24 via the lead frame substrate 20 and the relay board 22 of FIG. 4A, the light emitting element 26 is driven by the IC 24, and an optical signal output from the light emitting element 26 is projected toward the opening 12 of the connection part 4. To the contrary, when an optical signal strikes from outside into the opening 12, the optical signal is received by the light receiving element 28, where it is converted into an electric signal, and the electric signal output from the light receiving element 28 is input via the relay board 22 and the lead frame substrate 20 to the predetermined circuitry of the apparatus body 2.

The connection parts 4 having the described arrangement are connected as shown in FIG. 4B via the interconnection member 5 of an elongate cylindrical form smaller in diameter than the connection parts 4, internal spaces 40 of the two connection parts 4 and an internal space 42 of the interconnection member 5 communicate with each other to constitute a light transmitting space 50 between the two electronic apparatuses 1. Further, the light emitting element 26 and the light receiving element 28 of the connected two connection parts 4 oppose each other with the light transmitting space 50 in between, so that an optical signal projected from the light emitting element 26 in one connection part 4 is transmitted in the light transmitting space 50 and received by the light receiving element 28 in the other connection part 4. At this time, because the light transmitting space 50 is a closed space enclosed by peripheral walls of the connection parts 4 and the interconnection member 5, the optical signal is free from the fear of external leakage, so that safe and ensured transmission and reception of the optical signal are performed between the two electronic apparatuses 1.

When connection of the connection parts 4 is released, the shielding lid 16 which has been pressed to be opened as shown in FIG. 3B by the interconnection member 5 automatically returns to the condition of FIG. 3A, closing the opening 12. Therefore, when the two electronic apparatuses 1 are not connected, even if an optical signal is output from electronic apparatus 1 by mistake, the optical signal is shielded by the shielding lid 16 of the connection part 4 of this electronic apparatus 1 and kept from being projected outside.

Although, for the convenience of illustration, the shielding lid 16 shown in FIG. 4A is omitted from FIG. 4B, between an inner peripheral surface of the connection part 4 and an outer peripheral surface of the interconnection member 5 there actually exists a shielding lid 16 pressed by the interconnection member 5 and opened. Further, although, in FIG. 4B, light emitting elements 26 and light receiving elements 28 on both sides are not in right opposition to each other, the distances between the respective light emitting elements 26 and lenses 30 for converging light projected therefrom are adjusted and then projection angles of transmitted light of the lenses 30 are adjusted, so that an optical signal projected from a light emitting element 26 at one side can be received by a light receiving element 28 at the other side. It also is possible as a matter of course to have the light emitting element 26 and the light receiving element 28 set in right opposition to each other, thereby eliminating the necessity of adjustment.

(Second embodiment of an optically communicable electronic apparatus)

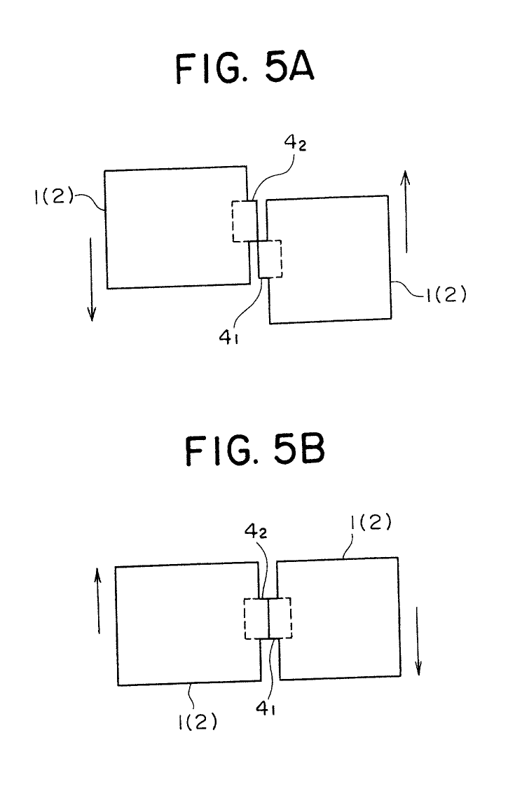

There will be described below another example of embodiment of an optically communicable electronic apparatus according to the present invention, with reference to FIG. 5A to FIG. 9. In this example of electronic apparatus, as shown in FIG. 5A, when a connection part 4₁ and a connection part 4₂ of two electronic apparatuses 1 are slid relative to each other in directions of arrows in the figure, the connection part 4₁ and the connection part 4₂ are connected to thereby connect the electronic apparatuses 1. On the other hand, as shown in FIG. 5B, when the connection parts 4₁ and 4₂ of the connected two electronic apparatuses 1 are slid relative to each other in directions of arrows in the figure (in opposite directions to the case of connection), connection of the connection parts 4₁ and 4₂ is released to thereby separate the electronic apparatuses 1 from each other.

The two electronic apparatuses 1 have a basic constitution to be the same as the first embodiment, and a notebook type personal computer is employed for their apparatus bodies 2, and the connection parts 4₁ and 4₂ are provided thereto. However, the structure of the connection parts 4₁ and 4₂ is different from that in the first embodiment. More specifically, the connection part 4₁ provided to one electronic apparatus 1 is made as a male connection part, and the connection part 4₂ provided to the other electronic apparatus 1 is made as a female connection part, to be connectable to and releasable from each other.

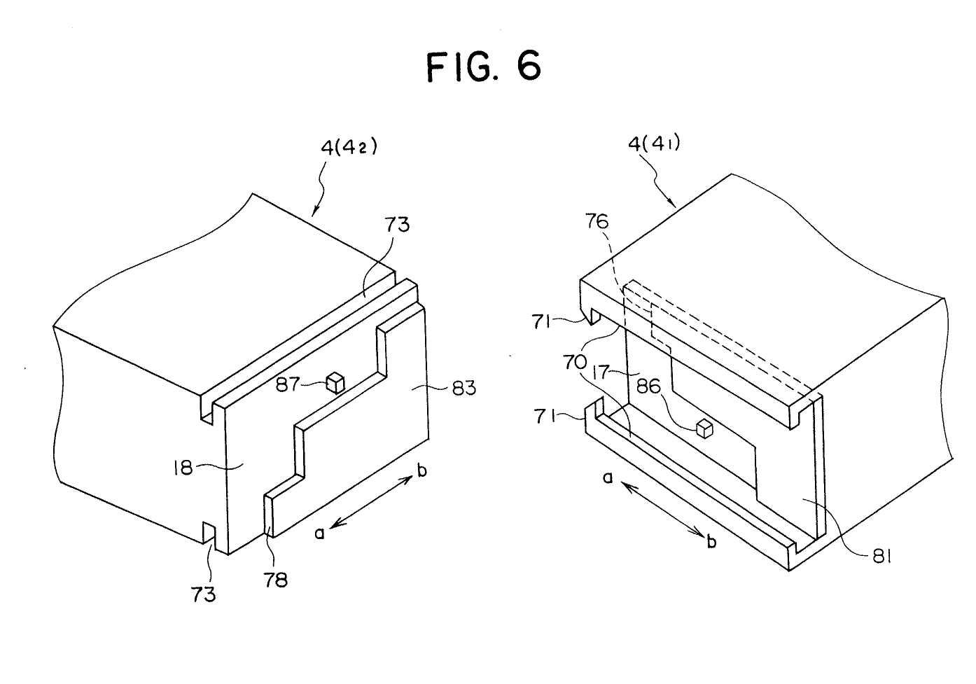

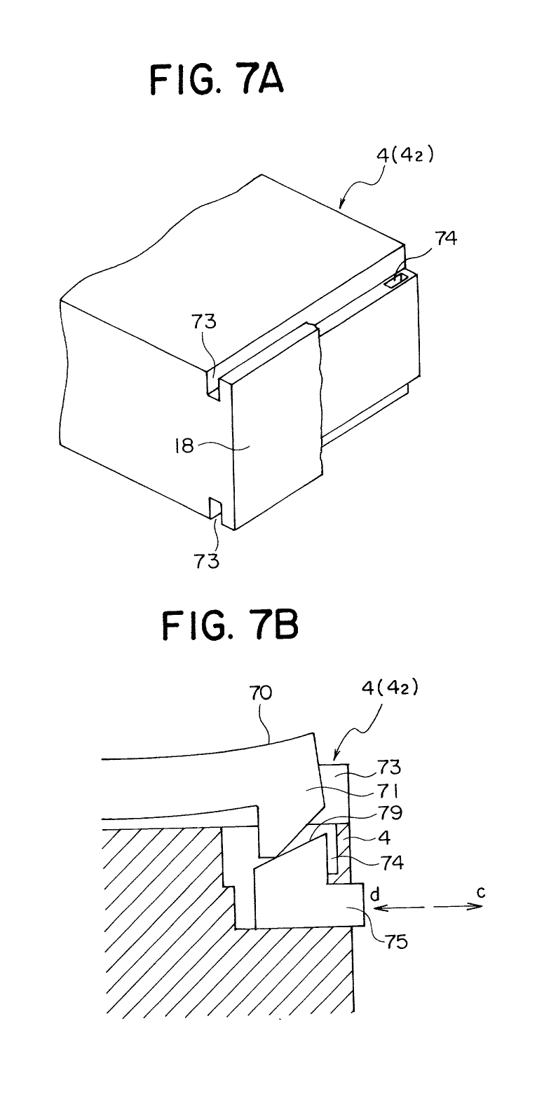

The male connection part 4₁ is prism-tubular as in FIG. 6, in which a connection side end face 17 has at the top and bottom thereof elongate fitting parts 70 formed in opposition, the fitting parts 70 being each respectively formed at one longitudinal end thereof with a hook-shaped locking part 71. The female connection part 4₂ also is prism-tubular as in FIG. 6, in which a connection side end face 18 has fitting grooves 73 formed at the top and bottom thereof, so that the fitting parts 70 of the male connection part 4₁ are connectable to and releasable from the fitting grooves 73. As shown in FIG. 7A, fitting groove 73 is formed at one longitudinal end thereof (at the final end in the sliding direction) with a locking hole 74. As shown in FIG. 7B, below the locking hole 4 is disposed a releasing piece 75, of which an upper end part projects inside the locking hole 74. The releasing piece 75 is normally pulled in the direction of arrow c in FIG. 7B by a spring (not shown), to be held in a predetermined position, and when it is moved in the direction of arrow d in the figure against pulling of the spring, a tapered face 79 of the releasing piece 75 is pushed onto the locking part 71, for release from the locking hole 74.

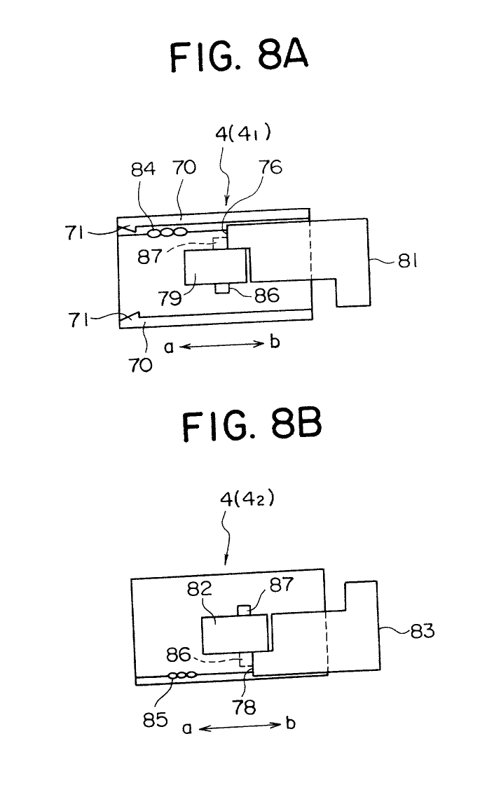

In the connection side end face 17 of the male connection part 4₁ of FIG. 6 is provided an opening 79 as in FIG. 8A, and outside the opening 79 is provided a shielding lid 81 to be slidable in the direction of arrows a-b. In the connection side end face 18 of the female connection part 4₂ of FIG. 6 is provided an opening 82 as in FIG. 8B, and outside the opening 82 is provided a shielding lid 83 to be slidable in the direction of arrows a-b. The shielding lids 81 and 83 are normally pulled in the direction of arrow a by springs 84 and 85 shown in FIG. 8A and FIG. 8B, to close the openings 79 and 82, respectively, and when they are slid in the direction of arrow b in the figure against pulling of the springs 84 and 85, the openings 79 and 82 are opened, respectively.

As in FIG. 6 and FIGS. 8A and 8B, under the opening 79 in the connection side end face 17 of the male connection part 4₁ is projected a cubic operation part 86, and over the opening 82 in the connection side end face 18 of the female connection part 4₂ is projected a cubic operation part 87.

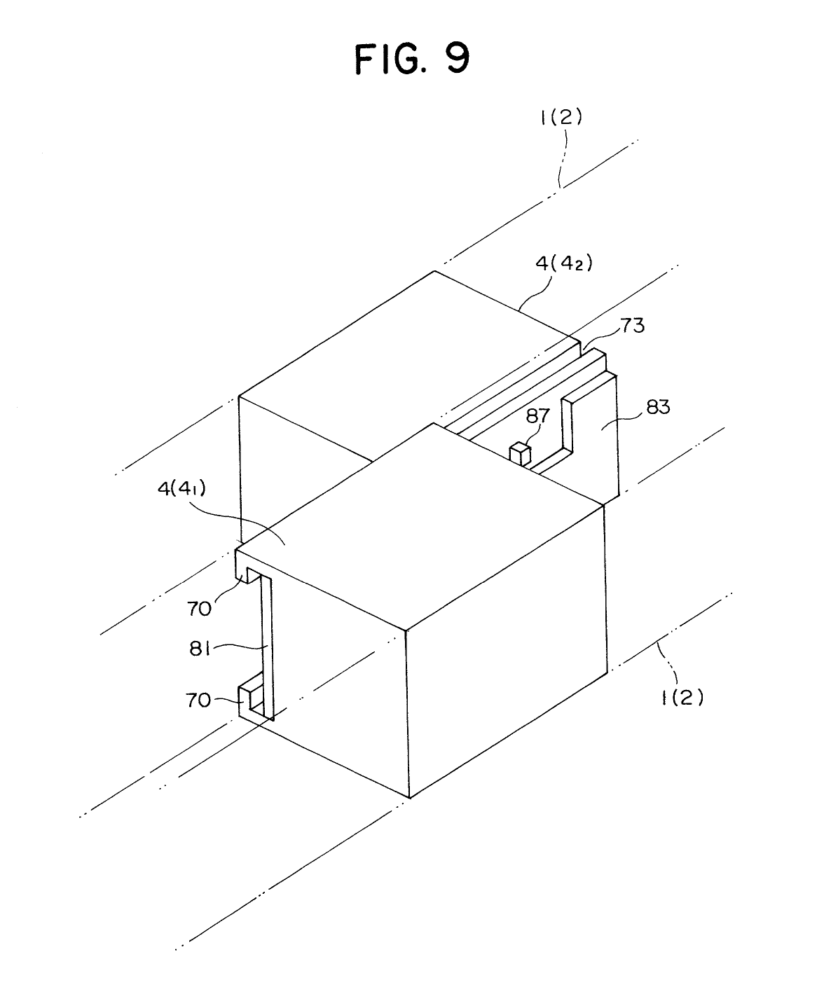

The male connection part 4₁ and the female connection part 4₂ are connected as follows. As in FIG. 5A and FIG. 9, the locking part 71 provided on the fitting part 70 of the male connection part 4₁ is fitted to one end of the fitting groove 73 of the female connection part 4₂, and thereafter, the connection parts 4₁ and 4₂ are slid in the direction of arrows in FIG. 5A. By the sliding, the fitting part 70 of the male connection part 4₁ is fitted in the fitting groove 73 of the female connection part 4₂, so that the two connection parts 4₁ and 4₂ are connected as in FIG. 5B, and the electronic apparatuses 1 are connected as in the same figure. In this case, the locking part 71 (FIG. 6) provided on the fitting part 70 of the male connection part 4₁ is locked to the locking hole 74 (FIG. 7A) provided to the fitting groove 73 of the female connection part 4₂, so that connection between the two connection parts 4₁ and 4₂ is kept from being carelessly released, and connection of the electronic apparatuses 1 also is kept from being carelessly released.

In the above-noted connection in which the male connection part 4₁ and the female connection part 4₂ are slid, on the way of sliding, a receiving surface 76 of the shielding lid 81 of the male connection part 4₁ and the operation part 87 of the female connection part 4₂ are brought into abutment (FIG. 8A), and a receiving surface 78 of the shielding lid 83 of the female connection part 4₂ and the operation part 86 of the male connection part 4₁ are brought into abutment (FIG. 8B). When the sliding is still advanced, the shielding lid 81 of the male connection part 4₁ is pushed by the operation part 87 of the female connection part 4₂ and slid in the direction of arrow b in FIG. 8A, causing the opening 79 of the male connection part 4₁ to open, and the shielding lid 83 of the female connection part 4₂ is pushed by the operation part 86 of the male connection part 4₁ and slid in the direction of arrow b in FIG. 8B, causing the opening 82 of the female connection part 4₂ to open.

When the openings 79 and 82 of the two connection parts 4₁ and 4₂ are opened as described above, internal spaces of the two connection parts 4₁ and 4₂ communicate with each other to form a light transmitting space between the two electronic apparatuses 1 connected to each other as in FIG. 5B. Moreover, through the formed light transmitting space, an optical transmitter in one connection part 4 and an optical receiver in the other connection part 4 oppose each other. Therefore, an optical signal projected from the optical transmitter in one connection part 4 is transmitted through the light transmitting space and received by the optical receiver in the other connection part 4. In this case also, because the light transmitting space is a closed space enclosed by peripheral walls of the two connection parts 4, the optical signal is kept from being leaked outside, so that safe and ensured transmission and reception of an optical signal is performed between the two electronic apparatuses 1.

Separation of the two electronic apparatuses 1 connected as in FIG. 5B is performed as follows. The releasing piece 75 shown in FIG. 7B is moved in the direction of arrow d. During this movement, the locking part 71 is pushed up by the tapered face 79 of the releasing piece 75, so that the locking part 71 is released from the locking hole 74. Thereafter, the connection parts 4₁ and 4₂ are both slid in the direction arrow of FIG. 5B (in opposite direction to the case of connection), thereby releasing the mating between the fitting part 70 and the fitting groove 73. By this release, the two electronic apparatuses 1 provided with the connection parts 4₁ and 4₂ are separated. In the sliding in opposite direction, because pushing operations to the shielding lids 81 and 83 by the operation parts 86 and 87 of the respective connection parts 4₁ and 4₂ are released, the shielding lids 81 and 83 of the respective connection parts 4₁ and 4₂ are pulled back in the direction of arrow a by the springs 84 and 85 of FIG. 8A and FIG. 8B, respectively, so that the openings 79 and 82 of the respective connection parts 4₁ and 4₂ are automatically closed by the shielding lids 81 and 83. Therefore, when the two electronic apparatuses 1 are not connected, even if an optical signal is output from electronic apparatus 1 by mistake, the optical signal is shielded by the shielding lid 76 of the connection part 4 of this electronic apparatus 1 and kept from being projected outside.

(Third embodiment of an optically communicable electronic apparatus)

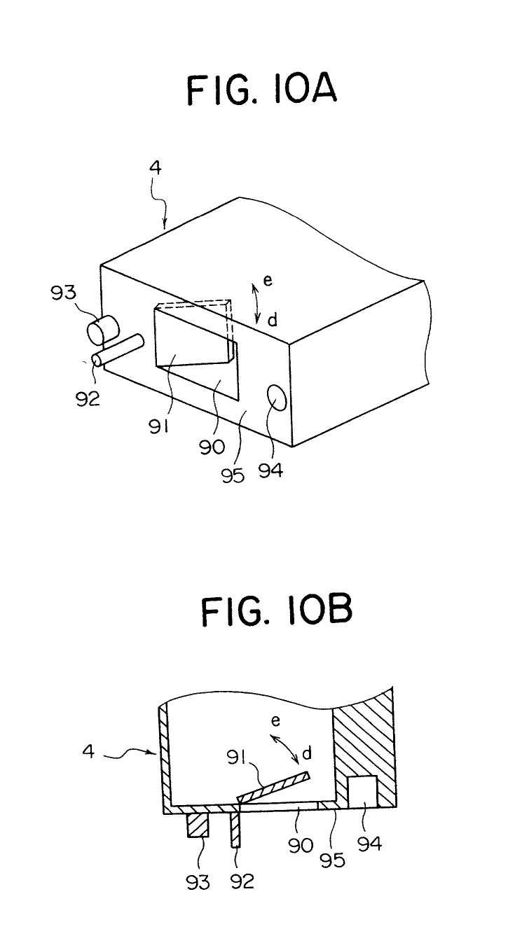

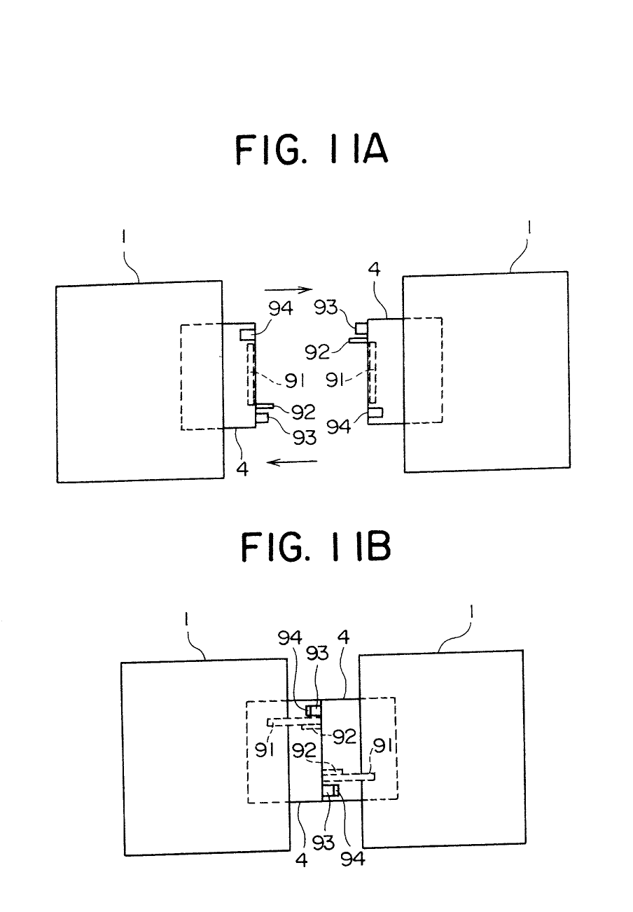

There will be described below still another example of embodiment of an optically communicable electronic apparatus according to the present invention, with reference to FIG. 10A to FIG. 11B. This example of electronic apparatus 1 is identical in basic constitution to the first embodiment, except for the constitution of a connection part 4 the electronic apparatus 1 has.

The connection part 4 is prism-tubular as in FIG. 10A and FIG. 10B, in which a connection side end face 95 has an opening 90 opened therein, and outside the opening 91 is provided a shielding lid 91. The shielding lid 91 can be swung in the direction of arrows d-e of FIGS. 10A and 10B, to thereby open and close the opening 90.

In the connection side end face 95, projected at one outer side of the opening 90 is a push pin 92, and at its outside is a guide pin 93. The guide pin 93 is bigger and shorter than the push pin 92. In the connection side end face 95, opened at the other outer side of the opening 90 is a guide hole 94.

As in FIG. 11A and FIG. 11B, the connection parts 4 provided to two electronic apparatuses 1 are reversed in sense at 180 degrees. Therefore, when the connection parts 4 of the two electronic apparatuses 1 are opposed to each other, the guide pin 93 at the connection part 4 of one electronic apparatus 1 is opposed to the guide hole 94 at the connection part 4 of the other electronic apparatus 1.

The connection parts 4 of the two electronic apparatuses 1 are connected as in FIG. 11B for connection of the two electronic apparatuses 1 as follows. As in FIG. 11A, the connection parts 4 of the two electronic apparatuses 1 are opposed and brought into abutment, and by the push pin 92 of one connection part 4 the shielding lid 91 of the other connection part 4 is pushed inside (in the direction of arrow e of FIG. 10), to open the opening 90 (FIG. 10). As the abutment between the connection parts 4 is still advanced, the guide pin 93 of the one connection part 4 is inserted into the guide hole 94 of the other connection part 4, so that the two connection parts 4 are connected and positioned. By this connection, the openings 90 of the two connection parts 4, as they are pressed to be open, communicate with each other to form a light transmitting space between the two electronic apparatuses 1, and through the light transmitting space, an optical transmitter in the one connection part 4 and an optical receiver in the other connection part 4 oppose each other. Therefore, an optical signal projected from the optical transmitter in the one connection part 4 is transmitted through the light transmitting space and received by the optical receiver in the other connection part 4. In this case also, because the light transmitting space is a closed space enclosed by peripheral walls of the two connection parts 4, the optical signal is kept from being leaked outside, so that safe and ensured transmission and reception of an optical signal is performed between the two electronic apparatuses 1.

For separation of two electronic apparatuses 1 connected to each other as in FIG. 11B, the electronic apparatuses 1 are pulled in directions in which they are separated, to pull out the guide pin 93 of one connection part 4 from the guide hole 94 of the other connection part 4, and are pulled in the same direction to separate the connection parts 4 from each other. By this separation, pushing action by the push pin 92 of the one connection part 4 to the shielding lid 91 of the other connection part 4 is released, so that the opening 90 is closed by the shielding lid 91. Therefore, when the two electronic apparatuses 1 are not connected, even if an optical signal is output from electronic apparatus 1 by mistake, the optical signal is shielded by the shielding lid 91 of the connection part 4 of this electronic apparatus 1 and kept from being projected outside.

(First embodiment of an optical component)

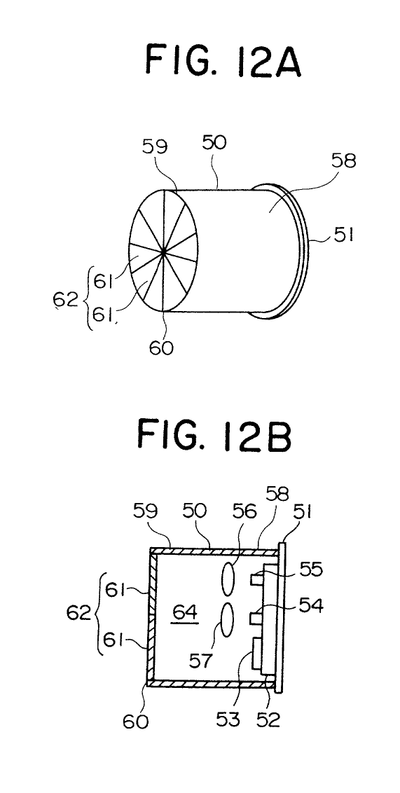

There will be described below an example of embodiment of an optical component according to the present invention, with reference to FIG. 12A and FIG. 12B. This example of optical component is identical in structure and function to the connection part 4 shown in FIG. 3A and FIG. 4A, which connection part 4 is configured as a separate body relative to an optically communicable electronic apparatus according to the present invention, and adapted to be applicable to the electronic apparatus.

This optical component is configured as a module by incorporating, in a cylindrical housing 50 shown in FIG. 12A, a lead frame substrate 51, a relay board 52, an IC 53, a light emitting element (LD) 54, a light receiving element (Pin-PD) 55, a lens 56 for converging projected light (an optical signal) from the light emitting element 54, to output as a converged flux of light, and a lens 67 for converging incident light (an optical signal) from outside, to focus on the light receiving element 55. The housing 50 is configured at one end side in the axial direction thereof as a mounting part 58 mountable to an electronic apparatus, and at the other end side as a connection part 59 connectable to and releasable from a connection part of another electronic apparatus, the connection part 59 having an opening 60 provided with a shielding lid 62. The shielding lid 62 is constituted with a multiple number of triangular rubber plates 61. The rubber plates 61 are identical in configuration and function to the rubber plates 14 shown in FIG. 3A and FIG. 3B.

The optical component in this embodiment is adapted, by mounting the mounting part 58 to an electronic apparatus 1 and providing the connection part 59 with an interconnection member as in FIG. 4B, to be connected to a connection part of an optical component mounted to another electronic apparatus. With this connection, the shielding lid 62 is automatically opened to have a light transmitting space formed by internal spaces 64 of the housings 50 of the two optical components (FIG. 11B) and an internal space of the interconnection member between the electronic apparatuses like the case of FIG. 4B, so that an optical signal can be transmitted in the space. When connection between the connection parts 59 of the optical components is released, the two electronic apparatuses to which the optical components are mounted are separated. Along the separation, the shielding lid 62 of the optical component is automatically closed, thereby closing the opening 60 of the housing 50. Therefore, when the electronic apparatuses are not connected, an optical signal projected from the light emitting element 54 is kept from being projected outside the housing 50.

(Second embodiment of an optical component)

Although the connection part 59 of the optical component in the above-noted embodiment is identical in structure and function to the connection part 4 of FIG. 3A, an optical component according to the present invention may have a connection part 59 identical in structure and function to the connection part 4 of FIG. 6 or FIG. 10.

(Other embodiments)

An optically communicable electronic component according to the present invention as well as an electronic component having an optical component mounted thereto may range electronic apparatuses besides the notebook type personal computer, such as a digital still camera, a digital video camera, a game machine, an audio apparatus, etc.

A connection part in an optically communicable electronic apparatus according to the present invention as well as a housing in an optical component according to the present invention is preferably made of a shading material, but may be made of a transparent material subject to post-processes such as coating a shading paint on the surface or vapor deposition thereto. It is essential for transmitted light in a light transmitting space to be kept from being leaked outside. As to configuration also, there may be employed a variety of other configurations than the depicted cylindrical form or prism-tubular form, for example, an arbitrary configuration such as an ellipse-tubular form or a multi-polygonal tubular form.

The semiconductor laser diode to be used as a light emitting element in a connection part or housing may be an ordinary Fabry-Perot type LD (Laser Diode), a surface emission type LD (VCSEL), or other light emitting elements. In essence, it may well be a high-output one capable of transmitting a large capacity of data at a high rate.

### EFFECTS OF THE INVENTION

An optically communicable electronic apparatus according to the present invention has the following effects.

(1) An optical signal is transmitted in an internal space of a connection part, and the internal space is a closed space, and therefore, the optical signal being transmitted is kept from being leaked outside or from being irradiated on a human body by mistake. It therefore is possible to use a high-output semiconductor laser diode as a light source of the optical signal, so that a large capacity of data can be transmitted and received at a high rate.

(2) There is provided a shielding mechanism configured, when the connection part is not connected to a connection part of another electronic apparatus, to close an opening, effecting a shielding such that the optical signal output from an optical transmitter is prevented from being projected outside the electronic apparatus, and simple when the connection part is connected to the connection part of the other electronic apparatus, to release the shielding. Therefore, except when in communication, even if an optical signal is output by mistake, there is no fear of its irradiation such as on a human body. For this reason also, it is allowed to use a high-output semiconductor laser diode for a light source of the optical signal, so that a large capacity of data can be transmitted and received at a high rate.

An optical component according to the present invention can be incorporated in an electronic apparatus to thereby implement an optically communicable electronic apparatus according to the present invention, and is thus allowed to achieve like effects the above-noted effects by mounting to the electronic apparatus.

What is claimed is:

1. An optically communicable electronic apparatus comprising:
an optical transmitter;
an optical receiver;
a connection part capable of connection to and disconnection from a connection part of another electronic apparatus;
an internal space of the connection part; and
a shielding mechanism provided at an opening of the connection part, wherein
the internal space of the connection part is configured, when the connection part is connected to the connection part of the other electronic apparatus, to communicate with an internal space of the connection part of the other electronic apparatus, constituting a light transmitting space between the two electronic apparatuses, and
the shielding mechanism is configured, when the connection part is not connected to the connection part of the other electronic apparatus, to close the opening, effecting a shielding not to project an optical signal output from the optical transmitter outside the electronic apparatus, and when the connection part is connected to the connection part of the other electronic apparatus, to open the opening, allowing the optical signal to be transmitted in the light transmitting space.

2. An optically communicable electronic apparatus according to claim 1, wherein a light source of the optical transmitter comprises a semiconductor laser diode.

3. An optically communicable electronic apparatus according to claim 1 or 2, wherein the connection part is tubular, and connectable directly or via an interconnection member to the connection part the other electronic apparatus has.

4. An optical component comprising:
a light emitting element;
a light receiving element;
a lens for converging, to output, light projected from the light emitting element;
a lens for converging light incident from outside, to focus on the light receiving element; and
a housing capable of accommodating the light emitting element, the light receiving element, and the lenses, wherein
the housing has a mounting part to be mounted to an electronic apparatus, a connection part capable of connection to and disconnection from another electronic apparatus, and an internal space configured, when the connection part is connected to an optical component mounted to the other electronic apparatus, to communicate with an internal space of the optical component mounted to the other electronic apparatus, constituting a light transmitting space between the two electronic apparatuses, and
an opening of the connection part the housing has is provided with a shielding mechanism, and the shielding mechanism is configured, when the connection part is not connected to the optical component mounted to the other electronic apparatus, to close the opening, effecting a shielding such that an optical signal output from the light emitting element is not projected outside the housing, and when the connection part is connected to the optical component mounted to the other electronic apparatus, to open the opening, allowing the optical signal to be transmitted in the light transmitting space.

5. An optical component according to claim 4, wherein the light emitting element comprises a semiconductor laser diode.

6. An optical component according to claim 4 or 5, wherein the housing is tubular, and connectable directly or via an interconnection member to a housing of the optical component mounted to the other electronic apparatus.
